(19) United States
(12) Patent Application Publication
(10) Pub. No.: US 2016/0004981 A1
(43) Pub. Date: Jan. 7, 2016

(54) METHOD AND APPARATUS FOR BOOKING CONFERENCE SITE, AND CONFERENCE SYSTEM

(71) Applicant: Huawei Technologies Co., Ltd., Shenzhen (CN)

(72) Inventors: Yafei WANG, Shenzhen (CN); Guanchun RUAN, Shenzhen (CN); Bo LIU, Shenzhen (CN)

(21) Appl. No.: 14/857,431

(22) Filed: Sep. 17, 2015

Related U.S. Application Data
(63) Continuation of application No. PCT/CN2013/072837, filed on Mar. 19, 2013.

(51) Int. Cl. G06Q 10/02; G06Q 10/10

(52) U.S. Cl. CPC G06Q 10/025; G06Q 10/1095

(57) ABSTRACT

The present invention provides a method and an apparatus for booking a conference site, and a conference system. The method includes: acquiring location information of multiple participants and time information of a conference; acquiring schedule information and location information of multiple conference sites; respectively comparing the location information of the multiple participants and the time information of the conference with the location information and the schedule information of the multiple conference sites, to obtain a first comparison result; and allocating according to the first comparison result, conference sites that meet a distance requirement and are free within a time indicated by the time information of the conference in the multiple conference sites to the multiple participants. According to the present invention, a conference site booking device may be used to automatically allocate a conference site to a participant, which enables quick and effort-saving booking of a conference site.

### CROSS-REFERENCE TO RELATED APPLICATIONS

This application is a continuation of International Patent Application No. PCT/CN2013/072837, filed on Mar. 19, 2013, which is hereby incorporated by reference in its entirety.

### TECHNICAL FIELD

The present invention relates to the field of video communications, and in particular, to a method and an apparatus for booking a conference site, and a conference system.

### BACKGROUND

At present, with the increase of network bandwidth and continuous improvement of video/audio processing technologies, in consideration of reduction in travel expenses, companies have one after another begun to deploy video/audio conference systems, and the scale of internal video/audio conference sites of a company also becomes increasingly big.

Booking a video conference generally needs booking two or more conference sites that are in different geographical regions; how to arrange conference attending manners for different participants, how to select conference sites, and how to select a conference time all require advanced preparation of a conference site booker.

Every time a conference site is to be booked, a person who is responsible for booking the conference site needs to learn schedules of participants in advance, and needs to manually confirm whether conference sites at different locations are free, and then determines a conference site and a conference time. Because generally many conference sites need to be booked for a video/audio conference, it is very difficult to find appropriate conference sites and an appropriate conference time, and it needs to take a very long time.

Therefore, how to book a conference site quickly without much effort becomes an urgent issue.

### SUMMARY

Embodiments of the present invention provide a method and an apparatus for booking a conference site, and a conference system, which enable quick and effort-saving booking of a conference site.

A first aspect provides a method for booking a conference site, including: acquiring, by a conference site booking device, location information of multiple participants in a participant list and time information of a conference; acquiring, by the conference site booking device, schedule information and location information of multiple conference sites; respectively comparing, by the conference site booking device, the location information of the multiple participants and the time information of the conference with the location information and the schedule information of the multiple conference sites, to obtain a first comparison result; and allocating, by the conference site booking device according to the first comparison result, conference sites that meet a distance requirement and are free within a time indicated by the time information of the conference in the multiple conference sites to the multiple participants.

In a first possible implementation manner, the allocating conference sites that meet a distance requirement and are free within a time indicated by the time information of the conference in the multiple conference sites to the multiple participants includes: allocating, to each participant of the multiple participants, a candidate conference site whose distance to a location of the participant is less than a preset threshold and that is free within the time indicated by the time information of the conference in the multiple conference sites.

With reference to the first possible implementation manner of the first aspect, in a second possible implementation manner, in a case in which free candidate conference sites that are allocated to at least two participants of the multiple participants have an intersection set, the method further includes: randomly selecting, by the conference site booking device, one conference site for the at least two participants from multiple free candidate conference sites that are included in the intersection set.

With reference to the first possible implementation manner of the first aspect, in a third possible implementation manner, in a case in which free candidate conference sites that are allocated to at least two participants of the multiple participants have an intersection set, the method further includes: comparing, by the conference site booking device, total distances from locations of the at least two participants to all candidate conference sites of multiple free candidate conference sites that are included in the intersection set, to obtain a second comparison result; and selecting, by the conference site booking device for the at least two participants according to the second comparison result and from the multiple free candidate conference sites that are included in the intersection set, one conference site whose total distance to the at least two participants is the shortest, where a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

With reference to the first possible implementation manner of the first aspect, in a fourth possible implementation manner, in a case in which free candidate conference sites that are allocated to at least two participants of the multiple participants have an intersection set, the method further includes: comparing, by the conference site booking device, distances from locations of the at least two participants to all candidate conference sites of multiple free candidate conference sites that are included in the intersection set, to obtain a third comparison result; and selecting, by the conference site booking device according to the third comparison result, a conference site for the at least two participants from the multiple free candidate conference sites that are included in the intersection set, where the selected conference site meets a requirement that the number of participants whose distances to the selected conference site are less than a first threshold in the at least two participants be the largest.

With reference to the first possible implementation manner of the first aspect, in a fifth possible implementation manner, in a case in which free candidate conference sites that are allocated to at least two participants of the multiple participants have an intersection set, the method further includes: comparing, by the conference site booking device, percentages of the number of the at least two participants to capacities of all candidate conference sites of multiple free candidate conference sites that are included in the intersection set, to obtain a fourth comparison result; and selecting, by the conference site booking device for the at least two participants according to the fourth comparison result and from the multiple free candidate conference sites that are included in the intersection set, one conference site that has a highest percentage of the number of the at least two participants to a capacity of the candidate conference site.

With reference to the fifth possible implementation manner of the first aspect, in a sixth possible implementation manner, in a case in which one of the at least two participants attends the conference as a group, the method further includes: receiving, by the conference site booking device, an identifier of the group and the number of people in the group corresponding to the identifier that are input by a conference site booker in a user interface, where the number of the at least two participants is determined according to the number of people in the group and the number of other participants in the at least two participants.

With reference to the first possible implementation manner of the first aspect, in a seventh possible implementation manner, the method further includes: sending, by the conference site booking device to a user interface, identifiers of multiple free candidate conference sites that are allocated to one of the multiple participants, so that a conference site booker selects one conference site from the multiple free candidate conference sites; receiving, by the conference site booking device from the user interface, an identifier of the conference site selected by the conference site booker; and using, by the conference site booking device according to the identifier of the conference site selected by the conference site booker that is received from the user interface, the selected conference site as a conference site for the one of the multiple participants.

With reference to any one of the foregoing possible implementation manners of the first aspect, in an eighth possible implementation manner, the conference site booking device receives the time information of the conference that is input by the conference site booker in the user interface; the acquiring, by the conference site booking device, schedule information and location information of multiple conference sites includes: querying, by the conference site booking device according to the time information of the conference, a conference site information list for the location information and the schedule information of the conference sites; and the acquiring, by a conference site booking device, location information of multiple participants in a participant list and time information of a conference includes: receiving, by the conference site booking device, identification information of the multiple participants and the time information of the conference that are input by the conference site booker in the user interface; and querying, by the conference site booking device according to the identification information of the multiple participants, a personal information list for the location information of the multiple participants, where the conference site information list is stored in the conference site booking device or a conference site information server, and the personal information list is stored in the conference site booking device or a personal information server.

With reference to the first aspect or any one of the foregoing possible implementation manners of the first aspect, in a ninth possible implementation manner, the time information of the conference includes multiple conference periods; and the allocating conference sites that meet a distance requirement and are free within a time indicated by the time information of the conference in the multiple conference sites to the multiple participants includes: determining, by the conference site booking device from the multiple conference sites, conference site schemes corresponding to at least two periods for the multiple participants, where each conference site scheme of the conference site schemes corresponding to the at least two periods provides, for the multiple participants, the conference sites that meet the distance requirement and are free within the time indicated by the time information of the conference; and selecting, by the conference site booking device, an optimal conference site scheme from the conference site schemes corresponding to the at least two conference periods, where when compared with one or more other schemes of the conference site schemes corresponding to the at least two conference periods, conference sites in the optimal conference site scheme meet one of the following conditions: the sum of distances from the multiple participants to their respective allocated conference sites in the optimal conference site scheme is the smallest; the number of participants whose distances to their respective allocated conference sites in the optimal conference site scheme are less than the first threshold in the multiple participants is the largest; and a percentage of the total number of the multiple participants to a capacity of all conference sites in the optimal conference site scheme is the highest.

With reference to the first aspect or any one of the foregoing possible implementation manners of the first aspect, in a tenth possible implementation manner, the time information of the conference includes multiple conference periods; and the method further includes: receiving, by the conference site booking device, the identification information of the multiple participants that is input by the conference site booker in the user interface; and querying, by the conference site booking device, schedule information of the multiple participants according to the identification information of the multiple participants, where the schedule information of the multiple participants is stored in the conference site booking device or the personal information server; where, the allocating conference sites that meet a distance requirement and are free within a time indicated by the time information of the conference in the multiple conference sites to the multiple participants includes: removing, by the conference site booking device according to schedules indicated by the schedule information of the multiple participants and from the multiple conference periods, a conference period that conflicts with a schedule of at least one participant of the multiple participants, to obtain a remaining conference period; and respectively comparing, by the conference site booking device, the location information of the multiple participants and the remaining conference period with the location information and the schedule information of the multiple conference sites, and allocating, to the multiple participants, the conference sites that meet the distance requirement and are free within the time indicated by the time information of the conference in the multiple conference sites.

With reference to the first aspect or any one of the foregoing possible implementation manners of the first aspect, in an eleventh possible implementation manner, the method further includes: requesting, by the conference site booking device, a participant to whom no conference site is allocated in the multiple participants to use a mobile device to attend the conference.

A second aspect provides an apparatus for booking a conference site, including: an acquiring module, configured to acquire location information of multiple participants in a participant list and time information of a conference, and acquire schedule information and location information of multiple conference sites; a comparing module, configured to respectively compare the location information of the multiple participants and the time information of the conference that are acquired by the acquiring module with the location information and the schedule information of the multiple conference sites that are acquired by the acquiring module, to obtain a first comparison result; and an allocating module, configured to allocate, to the multiple participants according to the first comparison result obtained by the comparing module, conference sites that meet a distance requirement and are free within a time indicated by the time information of the conference in the multiple conference sites.

In a first possible implementation manner, the allocating module allocates, to each participant of the multiple participants, a candidate conference site whose distance to a location of the participant is less than a preset threshold and that is free within the time indicated by the time information of the conference in the multiple conference sites.

With reference to the first possible implementation manner of the second aspect, in a second possible implementation manner, in a case in which free candidate conference sites that are allocated to at least two participants of the multiple participants have an intersection set, the allocating module further randomly selects one conference site for the at least two participants from multiple free candidate conference sites that are included in the intersection set.

With reference to the first possible implementation manner of the second aspect, in a third possible implementation manner, in a case in which free candidate conference sites that are allocated to at least two participants of the multiple participants have an intersection set, the comparing module further compares total distances from locations of the at least two participants to all candidate conference sites of multiple free candidate conference sites that are included in the intersection set, to obtain a second comparison result; and the allocating module further selects, for the at least two participants according to the second comparison result and from the multiple free candidate conference sites that are included in the intersection set, one conference site whose total distance to the at least two participants is the shortest, where a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

With reference to the first possible implementation manner of the second aspect, in a fourth possible implementation manner, in a case in which free candidate conference sites that are allocated to at least two participants of the multiple participants have an intersection set, the comparing module further compares distances from locations of the at least two participants to all candidate conference sites of multiple free candidate conference sites that are included in the intersection set, to obtain a third comparison result; and the allocating module further selects, according to the third comparison result, a conference site for the at least two participants from the multiple free candidate conference sites that are included in the intersection set, where the selected conference site meets a requirement that the number of participants whose distances to the selected conference site are less than a first threshold in the at least two participants be the largest.

With reference to the first possible implementation manner of the second aspect, in a fifth possible implementation manner, in a case in which free candidate conference sites that are allocated to at least two participants of the multiple participants have an intersection set, the comparing module further compares percentages of the number of the at least two participants to capacities of all candidate conference sites of multiple free candidate conference sites that are included in the intersection set, to obtain a fourth comparison result; and the allocating module further selects, for the at least two participants according to the fourth comparison result and from the multiple free candidate conference sites that are included in the intersection set, one conference site that has a highest percentage of the number of the at least two participants to a capacity of the candidate conference site.

With reference to the fifth possible implementation manner of the second aspect, in a sixth possible implementation manner, in a case in which one of the at least two participants attends the conference as a group, the acquiring module further receives an identifier of the group and the number of people in the group corresponding to the identifier that are input by a conference site booker in a user interface, where the number of the at least two participants is determined according to the number of people in the group and the number of other participants in the at least two participants.

With reference to the first possible implementation manner of the second aspect, in a seventh possible implementation manner, the apparatus further includes: a sending module, configured to send, to a user interface, identifiers of multiple free candidate conference sites that are allocated by the allocating module to one of the multiple participants, so that a conference site booker selects one conference site from the multiple free candidate conference sites, where the acquiring module further receives, from the user interface, an identifier of the conference site selected by the conference site booker; and the allocating module further uses, according to the identifier of the conference site selected by the conference site booker that is received from the user interface, the selected conference site as a conference site for the one of the multiple participants.

With reference to any one of the foregoing possible implementation manners of the second aspect, in an eighth possible implementation manner, the acquiring module receives the time information of the conference that is input by the conference site booker in the user interface, queries, according to the time information of the conference, a conference site information list for the location information and the schedule information of the conference sites, receives identification information of the multiple participants and the time information of the conference that are input by the conference site booker in the user interface, and queries, according to the identification information of the multiple participants, a personal information list for the location information of the multiple participants, where the conference site information list is stored in the conference site booking device or a conference site information server, and the personal information list is stored in the conference site booking device or a personal information server.

With reference to the second aspect or any one of the foregoing possible implementation manners of the second aspect, in a ninth possible implementation manner, the time information of the conference includes multiple conference periods; the allocating module determines, from the multiple conference sites, conference site schemes corresponding to at least two periods for the multiple participants, where each conference site scheme of the conference site schemes corresponding to the at least two periods provides, for the multiple participants, the conference sites that meet the distance requirement and are free within the time indicated by the time information of the conference; and the allocating module selects an optimal conference site scheme from the conference site schemes corresponding to the at least two conference periods, where when compared with one or more other schemes of the conference site schemes corresponding to the at least two conference periods, conference sites in the optimal conference site scheme meet one of the following conditions: the sum of distances from the multiple participants to their respective allocated conference sites in the optimal conference site scheme is the smallest; the number of participants whose distances to their respective allocated conference sites in the optimal conference site scheme are less than the first threshold in the multiple participants is the largest; and a percentage of the total number of the multiple participants to a capacity of all conference sites in the optimal conference site scheme is the highest.

With reference to the second aspect or any one of the foregoing possible implementation manners of the second aspect, in a tenth possible implementation manner, the time information of the conference includes multiple conference periods; the acquiring module further receives the identification information of the multiple participants that is input by the conference site booker in the user interface, and queries schedule information of the multiple participants according to the identification information of the multiple participants, where the schedule information of the multiple participants is stored in the conference site booking device or the personal information server; and the allocating module removes, according to schedules indicated by the schedule information of the multiple participants and from the multiple conference periods, a conference period that conflicts with a schedule of at least one participant of the multiple participants, to obtain a remaining conference period, respectively compares the location information of the multiple participants and the remaining conference period with the location information and the schedule information of the multiple conference sites, and allocates, to the multiple participants, the conference sites that meet the distance requirement and are free within the time indicated by the time information of the conference in the multiple conference sites.

With reference to the second aspect or any one of the foregoing possible implementation manners of the second aspect, in an eleventh possible implementation manner, the allocating module further requests a participant to whom no conference site is allocated in the multiple participants to use a mobile device to attend the conference.

A third aspect provides a conference system, including: the foregoing apparatus for booking a conference site, configured to send a conference start notification when conference time arrives; and a multipoint control unit, configured to receive the conference start notification sent by the apparatus for booking a conference site, and according to the conference start notification, call a conference site corresponding to a conference site selected by the apparatus for booking a conference site to attend a conference.

In the embodiments of the present invention, a conference site booking device may allocate a conference site to a participant according to location information of the participant, time information of a conference, and location information and schedule information of conference sites, so as to automatically allocate conference sites to participants at different locations, which enables quick and effort-saving booking of a conference site for a conference and reduces the complexity of video conference booking.

### BRIEF DESCRIPTION OF DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic frame diagram of a conference system according to an embodiment of the present invention;

FIG. 2 is a schematic flowchart of a method for booking a conference site according to an embodiment of the present invention;

FIG. 3A is a schematic diagram of a manner of collecting personal location information according to an embodiment of the present invention;

FIG. 3B is a schematic diagram of a manner of collecting personal location information according to another embodiment of the present invention;

FIG. 3C is a schematic diagram of a manner of collecting personal location information according to still another embodiment of the present invention;

FIG. 3D is a schematic diagram of a manner of collecting conference site location information according to an embodiment of the present invention;

FIG. 3E is a schematic diagram of a manner of collecting conference site location information according to another embodiment of the present invention;

FIG. 4A is a schematic flowchart of a process of conference site booking according to an embodiment of the present invention;

FIG. 4B is a schematic diagram of a user interface according to an embodiment of the present invention;

FIG. 5A is a schematic diagram of locations of conference sites and participants according to an embodiment of the present invention;

FIG. 5B is a schematic diagram of locations of participants and conference sites according to another embodiment of the present invention;

FIG. 6 is a schematic flowchart of a process of conference site booking according to another embodiment of the present invention;

FIG. 7 is a schematic structural diagram of an apparatus for booking a conference site according to an embodiment of the present invention;

FIG. 8 is a schematic structural diagram of an apparatus for booking a conference site according to another embodiment of the present invention;

FIG. 9 is a schematic structural diagram of a conference site booking device according to an embodiment of the present invention;

FIG. 10 is a schematic structural diagram of a conference system according to an embodiment of the present invention; and

FIG. 11 is a schematic structural diagram of a conference system according to another embodiment of the present invention.

### DESCRIPTION OF EMBODIMENTS

The following clearly describes the technical solutions in the embodiments of the present invention with reference to the accompanying drawings in the embodiments of the present invention. Apparently, the described embodiments are some but not all of the embodiments of the present invention. All other embodiments obtained by a person of ordinary skill in the art based on the embodiments of the present invention without creative efforts shall fall within the protection scope of the present invention.

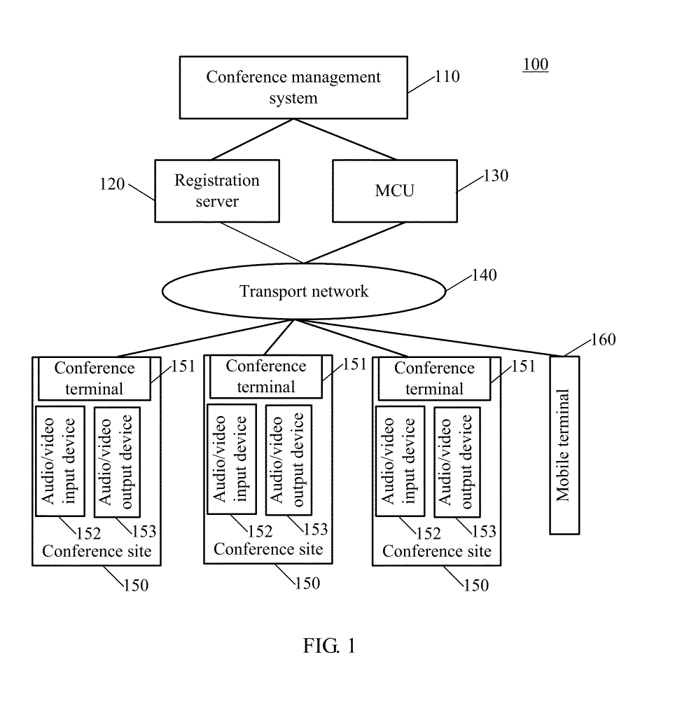

FIG. 1 is a schematic frame diagram of a conference system 100 according to an embodiment of the present invention. The conference system 100 may include a conference management system 110, a registration server 120, a multipoint control unit (Multipoint Control Unit, MCU) 130, and multiple conference sites 150. The registration server 120 and the multipoint control unit 130 may communicate with the multiple conference sites 150 by using a transport network 140. In addition, a mobile terminal 160 may also attend a conference in a mobile manner.

The conference management system 110 manages booking (or reservation) and scheduling of video conferences together. The conference management system may manage multiple video/audio conference sites (or conference rooms). The video/audio conference sites may be distributed in different countries and cities geographically; and the quantities of people that can be accommodated by the conference sites (that is, capacities of the conference sites) may be the same, or may be different. In addition, the conference management system 110 may also schedule user devices, such as a mobile tablet and a smartphone, to attend a conference in a mobile manner. The MCU 130 is responsible for core switching, audio mixing, and screen splitting processing in the conference system. A main function of the registration server 120 includes receiving registrations of the MCU and the terminal and performing address resolution during calling, for example, resolving a number to an IP address.

For ease of description, conference convening manners in a video conference process are described. Video conferences include point-to-point (Point-to-Point) conferences and point-to-multipoint (Point-to-Multipoint) conferences. When convening of a video conference is described, a conference site at which a describer resides is called a local conference site, a local end for short; in a point-to-point conference convening manner, the other conference site communicating with the conference site at which the describer resides is called a peer conference site, a peer end for short; in a point-to-multipoint conference convening manner, other conference sites communicating with the conference site at which the describer resides are called remote conference sites, remote ends for short.

In addition, conference site is a logical concept; for convening of a video conference, not only a conference room is included, but also a conference terminal 151, an audio or video input device 152, and an audio or video output device 153 need to be included. The conference terminal 151 is configured to: receive a call from or initiate a call to a remote conference terminal; encode video and audio code streams that are collected by a local video input device (for example, a camera or a camera array) and a local audio input device (for example, a microphone or a microphone array), and then send the encoded code streams to the remote end; and decode a video/audio code stream from the remote end and output the code stream to a local audio or video output device 153.

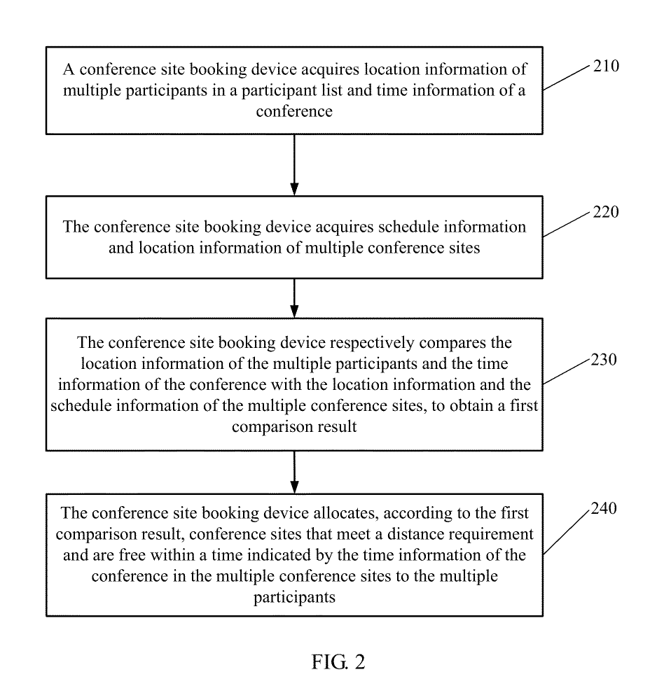

FIG. 2 is a schematic flowchart of a method for booking a conference site according to an embodiment of the present invention.

210. A conference site booking device acquires location information of multiple participants in a participant list and time information of a conference.

In a conference system, the conference site booking device may be an independent device, and is configured to book a conference site for a video or an audio conference. The conference site booking device may also be a part of a conference management system in the conference system, where the conference management system may provide a uniform conference management and maintenance platform, and is configured to execute functions such as conference scheduling, conference or conference site reservation, and conference control. The conference may refer to a video conference or an audio conference, or a combination of at least two types of conferences of a video conference, an audio conference, and a conference that is attended by using a mobile terminal.

For example, the participant list may include identification information and location information of at least two participants. The conference site booking device may acquire, from a web page or a user interface of an application program, the identification information of the participants that is input by a conference site booker; and query, according to the identification information of the participants, the location information of the participants in the participant list (for example, a personal address book directory) in a personal information server, or may directly acquire, from the user interface, the participant list that is input by the conference site booker. This embodiment of the present invention is not limited thereto; for example, the prestored location information of the participants in the participant list may also be read from a memory of the conference site booking device.

The conference site booking device may acquire, from a web page or a user interface of an application program, an identifier (for example, a conference name) of the conference and the time information of the conference that are input by a conference site booker, and this embodiment of the present invention is not limited thereto; for example, the time information of the conference that is prestored may also be read from a memory of the conference site booking device according to the identifier of the conference that is input in the user interface. The time information may be an exact conference time, for example, a period of time from a first moment to a second moment of a day, where the period of time equals conference duration, or may be a time range longer than the conference duration, for example, one morning, or one afternoon, or working hours of a day. The time information may be start time and end time, or may be a combination of the start time or end time and the conference duration.

220. The conference site booking device acquires schedule information and location information of multiple conference sites.

For example, the conference site booking device may acquire the schedule information and the location information of the multiple conference sites from a conference site information server or the memory in the conference site booking device according to identification information of the conference that is input in the user interface. The schedule information of a conference site may refer to a free or occupied condition of the conference site within each period of time. The location information may include information that is used to indicate a conference site location, for example, geographical information such as longitude and latitude. Optionally, information about a conference site may also include information such as a calling number of the conference site and a size of the conference site.

230. The conference site booking device respectively compares the location information of the multiple participants and the time information of the conference with the location information and the schedule information of the multiple conference sites, to obtain a first comparison result.

For example, a distance between a participant and a conference site may be determined according to location information of the participant and location information of the conference site, where the distance may be a linear distance, or may be an actual covered distance, and a conference site that is free within a preset conference time may be determined according to the time information of the conference and the schedule information of the conference sites.

240. The conference site booking device allocates, according to the first comparison result, conference sites that meet a distance requirement and are free within a time indicated by the time information of the conference in the multiple conference sites to the multiple participants.

According to this embodiment of the present invention, a conference site booking device may determine, according to time information of a conference and schedule information of conference sites, a conference site that meets a time requirement, and determine, according to location information of a participant and location information of the conference sites, a conference site that meets a distance requirement, so as to allocate a conference site that meets the time requirement and the distance requirement for the participant; for example, a conference site whose distance to a participant is less than a threshold and that is free within a specified conference time may be selected as a conference site for the participant.

In this embodiment of the present invention, a conference site booking device may allocate a conference site to a participant according to location information of the participant, time information of a conference, and location information and schedule information of conference sites, so as to automatically allocate conference sites to participants at different locations, which enables quick and effort-saving booking of a conference site for a conference and reduces the complexity of video conference booking.

According to this embodiment of the present invention, in 220, the conference site booking device may allocate, to each participant of the multiple participants, a candidate conference site whose distance to a location of the participant is less than a preset threshold and that is free within a time indicated by the time information of the conference in the multiple conference sites.

For example, the conference site booking device may compare the time information of the conference with the schedule information of the conference sites, to determine conference sites that fit the conference time; and then, according to location information of the conference sites that fit the conference time and location information of the participant, select, from the conference sites that fit the conference time, a conference site within a specific distance to the participant. Optionally, the conference site booking device may further compare the location information of the conference sites with the location information of the participant, to determine conference sites that are within a specific distance to the participant; and then, according to schedule information of the conference sites that are within the specific distance to the participant and the time information of the conference, select a conference site that fits the conference time from the conference sites that are within the specific distance to the participant. For example, the foregoing preset threshold may be 2 kilometers.

Because allocated candidate conference sites shrink the scope of conference sites available for selection, the conference site booker can book a conference site quickly without much effort from the candidate conference sites, or the conference site booking device selects, for a participant according to a preset constraint condition, a conference site that meets the constraint condition.

Optionally, as another embodiment, in a case in which free candidate conference sites that are allocated to at least two participants of the multiple participants have an intersection set, the method shown in FIG. 2 further includes that: the conference site booking device randomly selects one conference site for the at least two participants from multiple free candidate conference sites that are included in the intersection set.

For example, a first conference site and a second conference site are allocated to both a first participant and a second participant, and an intersection set of candidate conference sites for the first participant and the second participant includes the first conference site and the second conference site; and then, one conference site may be randomly selected from the first conference site and the second conference site as a conference site to be used by the first participant and the second participant together, which saves conference site resources.

Optionally, as another embodiment, in a case in which free candidate conference sites that are allocated to at least two participants of the multiple participants have an intersection set, the method shown in FIG. 2 further includes that: the conference site booking device calculates total distances from locations of the at least two participants to all candidate conference sites of multiple free candidate conference sites that are included in the intersection set, and compares results to obtain a second comparison result; and the conference site booking device selects, according to the second comparison result and from the multiple free candidate conference sites that are included in the intersection set, one conference site whose total distance to the at least two participants is the shortest for the at least two participants, where a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

For example, a first conference site and a second conference site are allocated to both a first participant and a second participant; if the sum of distances from the first conference site to the first participant and the second participant is less than the sum of distances from the second conference site to the first participant and the second participant, the first conference site is selected as a conference site to be used by the first participant and the second participant together, which saves time of the participants overall.

Further, a concept of participant priority may be introduced according to importance of participants, and when a total distance is calculated, corresponding weighting coefficients are used separately for different participants; for example, a weighting coefficient for the first participant is m, a weighting coefficient for the second participant is n, and distances from the two participants to one conference site are L1 and L2 respectively, and therefore, a formula for calculating the total distance is m*L1+n*L2.

Optionally, a concept of optimal route may further be introduced according to a traffic condition, and when a total distance is calculated, corresponding weighting coefficients are separately used for different participants; for example, a traffic congestion coefficient of a route from the first participant to one conference site is m, and a distance thereof is L1, and a traffic congestion coefficient of a route from the second participant to the conference site is n, and a distance thereof is L2, and therefore, a formula for calculating the total distance is m*L1+n*L2.

Optionally, as another embodiment, in a case in which free candidate conference sites that are allocated to at least two participants of the multiple participants have an intersection set, the method further includes that: the conference site booking device compares distances from locations of the at least two participants to all candidate conference sites of multiple free candidate conference sites that are included in the intersection set, to obtain a third comparison result; and the conference site booking device selects, according to the third comparison result, a conference site for the at least two participants from the multiple free candidate conference sites that are included in the intersection set, where the selected conference site meets a requirement that the number of participants whose distances to the selected conference site are less than a first threshold in the at least two participants be the largest.

For example, a first conference site and a second conference site are allocated to both a first participant and a second participant; if distances from the first participant and the second participant to the first conference site are both less than the first threshold, and a distance from the first participant or the second participant to the second conference site is greater than the first threshold, that is, the number of participants whose distances to the first conference site are less than the first threshold is greater than the number of participants whose distances to the second conference site are less than the first threshold, the first conference site is selected as a conference site to be used by the first participant and the second participant together. For example, the first threshold may be 200 m. Optionally, the first threshold may also be a distance that a common person can reach on foot within a preset time. When a distance from a participant to a conference site is calculated, a linear distance between the participant and the conference site may be calculated, or a length of an actual walk may be acquired with reference to Global Positioning System (Global Positioning System, GPS) navigation information.

Optionally, as another embodiment, in a case in which free candidate conference sites that are allocated to at least two participants of the multiple participants have an intersection set, the method further includes that: the conference site booking device compares percentages of the number of the at least two participants to capacities of all candidate conference sites of multiple free candidate conference sites that are included in the intersection set, to obtain a fourth comparison result; and the conference site booking device selects, for the at least two participants according to the fourth comparison result and from the multiple free candidate conference sites that are included in the intersection set, one conference site that has a highest percentage of the number of the at least two participants to a capacity of the candidate conference site.

For example, that the percentage of the number of the at least two participants to the capacity of the candidate conference site is the highest means that a utilization rate of a conference site allocated to the at least two participants is the highest (that is, a size is the most appropriate); for example, a first conference site has 10 seats and 9 participants are allocated, that is, a percentage of the number of participants that are allocated to the first conference site to a capacity of the first conference site is 90%, and a second conference site has 20 seats and 9 participants are allocated, that is, a percentage of the number of participants that are allocated to the second conference site to a capacity of the second conference site is 45%, and therefore, the first conference site is a conference site that has a highest utilization rate.

Optionally, as another embodiment, in a case in which one of the at least two participants attends the conference as a group, the method further includes that: the conference site booking device receives an identifier of the group and the number of people in the group corresponding to the identifier that are input by a conference site booker in a user interface, where the number of the at least two participants is determined according to the number of people in the group and the number of other participants in the at least two participants.

During booking of a video conference site, only one key participant may be specified, and there may be multiple related persons that are at a same location (for example, a same department) as the key participant and join a conference together. In this case, when the number of participants is calculated, increasing a weight of the key participant needs to be taken into account. For example, when multiple persons in a group (or department) that one participant belongs to need to attend the conference, during conference site booking, the conference site booker may input, in the user interface, an identifier (for example, a name or an employee ID) of one participant and the number of people attending the conference together; therefore, when the conference site booking device selects a conference site, the total number of people in the group who attend the conference is taken into account, so that the conference site booker does not need to input identifiers of all people in the group one by one, thereby lightening a workload of the conference site booker.

According to this embodiment of the present invention, a conference site booking device sends, to a user interface, identifiers of multiple free candidate conference sites that are allocated to one of multiple participants, so that a conference site booker selects one conference site from the multiple free candidate conference sites; the conference site booking device receives, from the user interface, an identifier of the conference site selected by the conference site booker; the conference site booking device uses, according to the identifier of the conference site selected by the conference site booker that is received from the user interface, the selected conference site as a conference site for the one of the multiple participants.

For example, in a case in which multiple candidate conference sites are allocated to a participant, the conference site booking device may return to the conference site booker the multiple candidate conference sites that are allocated to the participant, so that the conference site booker selects a conference site for the participant from the multiple candidate conference sites, or notifies the participant of the multiple candidate conference sites, so that the participant selects a conference site by himself/herself, thereby making conference site booking more flexible, more convenient, and more humanized.

According to this embodiment of the present invention, in 220, for each participant of the multiple participants, a conference site that meets a time requirement and is nearest to the participant is selected.

For example, for each participant, from conference sites that meet a time requirement of the conference, a conference site nearest to the participant is selected as a conference site for the participant, so that each participant spends a shortest traveling time when attending the conference.

According to this embodiment of the present invention, the conference site booking device receives the time information of the conference that is input by the conference site booker in the user interface; that the conference site booking device acquires schedule information and location information of multiple conference sites includes that: the conference site booking device queries, according to the time information of the conference, a conference site information list for the location information and the schedule information of the conference sites; and that a conference site booking device acquires location information of multiple participants in a participant list and time information of a conference includes that: the conference site booking device receives identification information of the multiple participants and the time information of the conference that are input by the conference site booker in the user interface; and the conference site booking device queries, according to the identification information of the multiple participants, a personal information list for the location information of the multiple participants, where the conference site information list is stored in the conference site booking device or a conference site information server, and the personal information list is stored in the conference site booking device or a personal information server.

For example, the conference site booking device may query the personal information list (for example, a personal address book directory of a company) according to the identification information of the multiple participants, to acquire the location information of the multiple participants. In a process of conference site booking, the conference site booker may also select the participant list in the user interface, and then the conference site booking device automatically completes selection of a conference site, without the need to manually select the conference site from all conference sites, so that conference booking work is more convenient and effort-saving. Further, when the conference site booking device cannot acquire identification information of a participant (for example, a new employee) from the personal address book directory, the conference site booking device may further instruct the conference site booker to directly input location information of the participant, so as to prevent a failure of conference site booking caused by nonexistence of location information of the participant in the personal address book directory.

The personal information list may be entered by using a tool or in a user interface provided by the personal information server, or may be indirectly acquired by the personal information server according to information about departments of employees of a company, which is not limited in this embodiment of the present invention.

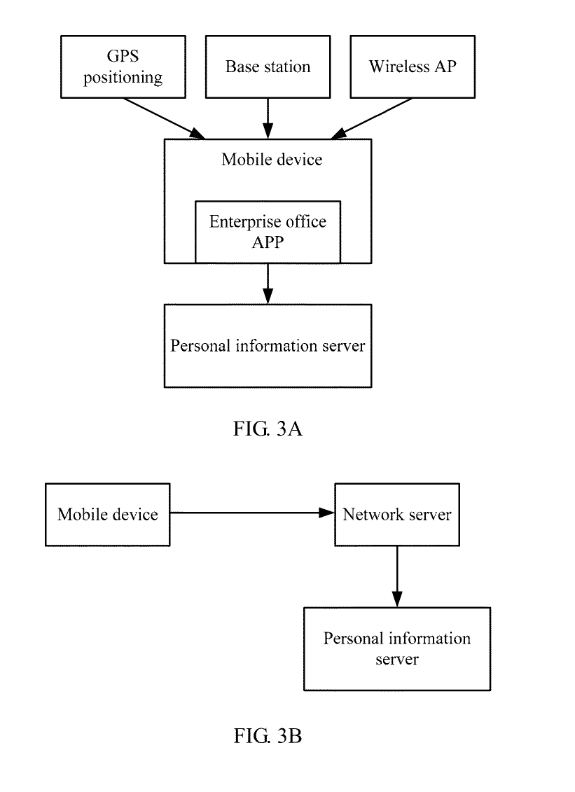

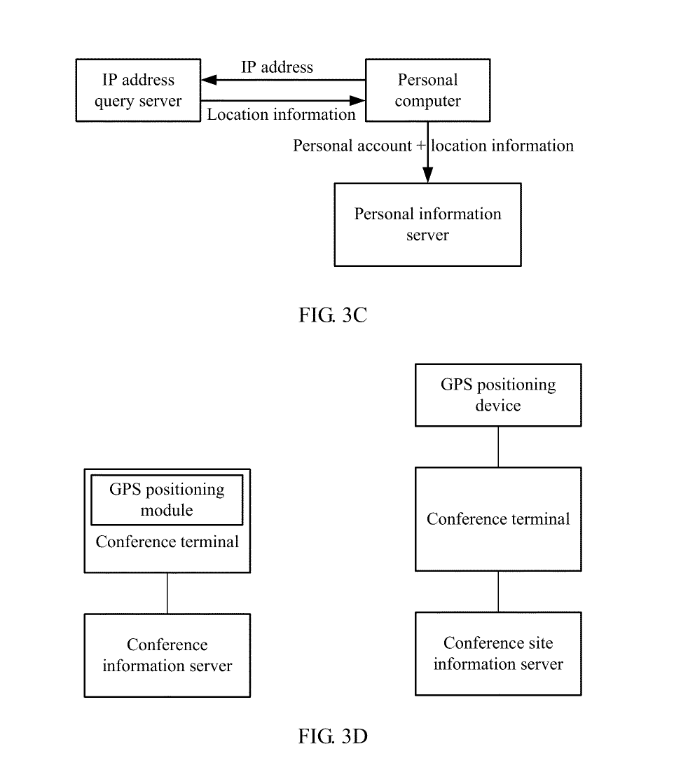

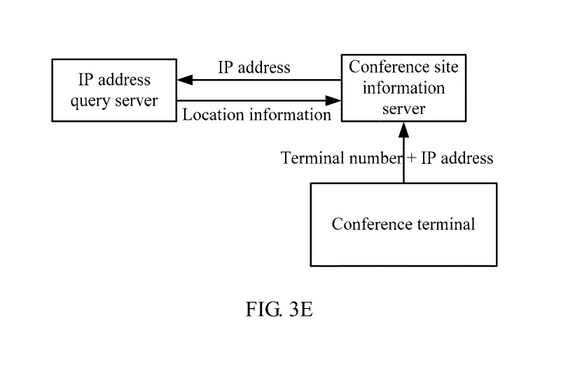

FIG. 3A is a schematic diagram of a manner of collecting personal location information according to an embodiment of the present invention.

Referring to FIG. 3A, location information (for example, geographical information) of a person who uses a mobile device for work may be collected by using GPS, a base station of an operator, a wireless access point (for example, WiFi hotspot), and the like and be synchronized to a personal information server (for example, an address book directory server) in a real-time manner by using an enterprise office automation APP installed on the mobile device.

FIG. 3B is a schematic diagram of a manner of collecting personal location information according to another embodiment of the present invention.

Referring to FIG. 3B, a person may share his/her location information with a network server (for example, a server providing a social media service or a communications service) by using instant messaging software, such as microblog, MSN (Microsoft Network), and UC (Universal Communication), and social media, such as a bulletin board system; a personal information server may acquire the location information from the network server.

FIG. 3C is a schematic diagram of a manner of collecting personal location information according to still another embodiment of the present invention.

Referring to FIG. 3C, an IP address of a personal computer used by a user may indirectly reflect geographical information of the user, and may be synchronized to a personal information server. For example, a person uses his/her account to log in to the personal computer, and the personal computer finds location information corresponding to the IP address by using an IP address query server. After acquiring the location information, the personal computer uploads the location information together with account information to the personal information server.

The conference site information may be entered by using a tool or in a user interface provided by a conference site information server, which is not limited in this embodiment of the present invention.

FIG. 3D is a schematic diagram of a manner of collecting conference site location information according to an embodiment of the present invention.

Referring to FIG. 3D, a GPS positioning module or positioning device may be built in a device of each conference site of a conference system, to acquire location information of each conference site and feed the location information back to a conference site information server. For example, a GPS module is built in a conference terminal to acquire location information; or, an independent GPS positioning device is added to acquire location information and send the location information to a conference terminal through a network, and then, the conference terminal reports the location information of the conference site to the conference site information server.

FIG. 3E is a schematic diagram of a manner of collecting conference site location information according to another embodiment of the present invention.

Referring to FIG. 3E, information, such as an IP address, of a device (for example, a conference terminal) in each conference site of a conference system may be used to indirectly reflect location information of the conference site. A conference terminal registers with a conference site information server, and reports a number and an IP address of the conference terminal; the conference site information server finds location information corresponding to the IP address by using an IP address query server.

According to the embodiment of the present invention, the time information of the conference includes multiple conference periods; the allocating conference sites that meet a distance requirement and are free within a time indicated by the time information of the conference in the multiple conference sites to the multiple participants includes that: the conference site booking device determines, from the multiple conference sites, conference site schemes corresponding to at least two periods for the multiple participants, where each conference site scheme of the conference site schemes corresponding to the at least two periods provides, for the multiple participants, the conference sites that meet the distance requirement and are free within the time indicated by the time information of the conference; and the conference site booking device selects an optimal conference site scheme from the conference site schemes corresponding to the at least two conference periods, where when compared with one or more other schemes of the conference site schemes corresponding to the at least two conference periods, conference sites in the optimal conference site scheme meet one of the following conditions: the sum of distances from the multiple participants to their respective allocated conference sites in the optimal conference site scheme is the smallest; the number of participants whose distances to their respective allocated conference sites in the optimal conference site scheme are less than the first threshold in the multiple participants is the largest; and a percentage of the total number of the multiple participants to a capacity of all conference sites in the optimal conference site scheme is the highest.

For example, if the conference site booking device finds that conference sites in multiple conference periods meet a time requirement, the conference site booking device may calculate a conference site scheme corresponding to each conference period, and select an optimal conference site scheme from schemes corresponding to the conference periods. During a booking process, the conference site booker does not need to manually select an exact conference time, but selects one or more expected time ranges, and the conference site booking device automatically recommends a conference time, thereby optimizing conference site selection.

Optionally, as another embodiment, the time information of the conference includes multiple conference periods; the method shown in FIG. 2 further includes that: the conference site booking device receives the identification information of the multiple participants that is input by the conference site booker in the user interface; and the conference site booking device queries schedule information of the multiple participants according to the identification information of the multiple participants, where the schedule information of the multiple participants is stored in the conference site booking device or the personal information server, where the allocating conference sites that meets a distance requirement and are free within a time indicated by the time information of the conference in the multiple conference sites to the multiple participants includes that: the conference site booking device removes, according to schedules indicated by the schedule information of the multiple participants and from the multiple conference periods, a conference period that conflicts with a schedule of at least one participant of the multiple participants, to obtain a remaining conference period; and the conference site booking device respectively compares the location information of the multiple participants and the remaining conference period with the location information and the schedule information of the multiple conference sites, and allocates, to the multiple participants, the conference sites that meet the distance requirement and are free within the time indicated by the time information of the conference in the multiple conference sites.

For example, manners of acquiring personal schedule information include but are not limited to the following listed manners: (1) personal conference attendance information is recorded in a conference management system, and a time in which a conference is already scheduled is considered to be occupied by a schedule; and (2) a personal information server provides a user interface for editing a personal schedule, and an employee of a company may update his/her schedule information to a personal information list by using a personal office device. If the conference site booking device learns, according to schedule information of a participant, that the participant has another plan in a period, a conference site in that period is not selected.

Optionally, as another embodiment, the method shown in FIG. 2 further includes that: the conference site booking device requests a participant to whom no conference site is allocated in the multiple participants to use a mobile device to attend the conference.

In a case in which a schedule of a participant conflicts with the conference time, for example, a participant may be in a business trip during the conference time, the conference site booking device may request the participant to use a mobile device to attend the conference, so that conference site selection is more flexible.

According to this embodiment of the present invention, during conference site booking, a conference site booker may book a conference site by selecting a participant, instead of directly selecting a conference site. A conference site booking device analyzes geographical locations of a participant and a conference site, and allocates a conference site nearest to the participant to the participant, which is not limited in this embodiment of the present invention. For example, the conference site booking device may select a conference site nearest to all participants, or may select, within a specific distance range, a conference site to which fewest people need to drive, or, in terms of resource use, may select, within a specific distance range, a conference site that has a most suitable size for the total number of multiple participants.

In the following, the embodiments of the present invention are described in more detail with reference to specific examples.

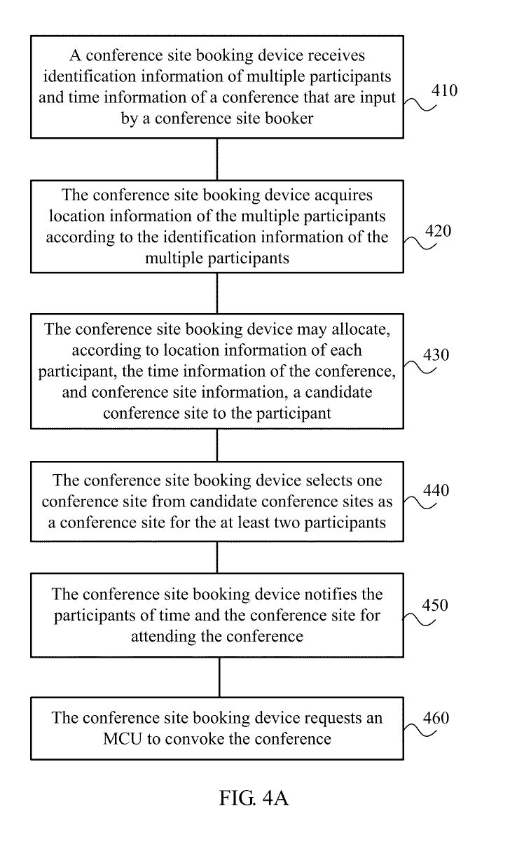

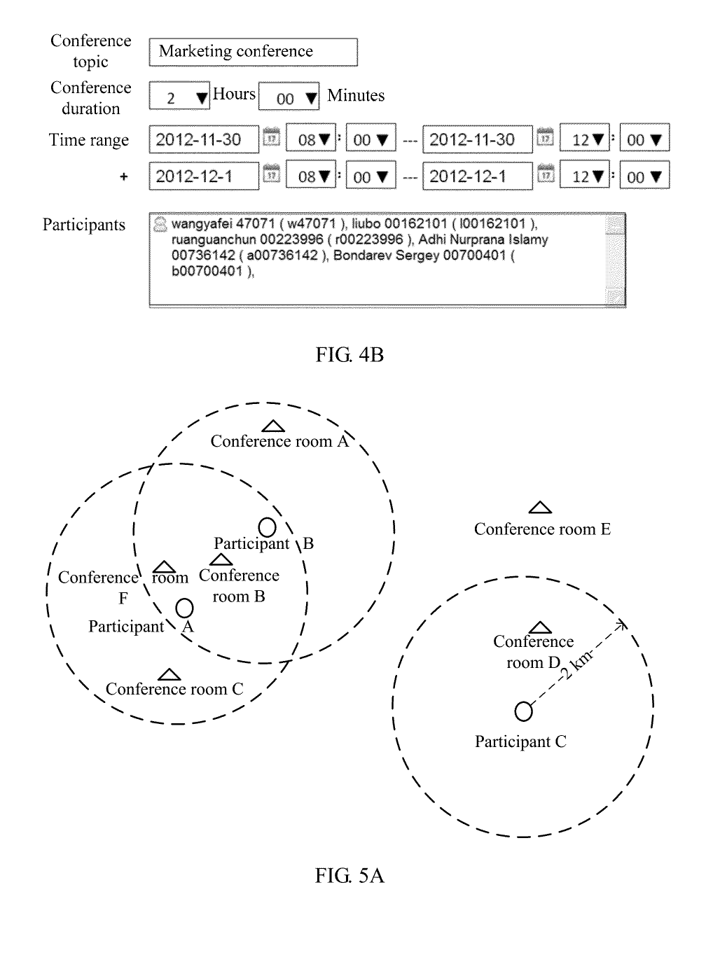

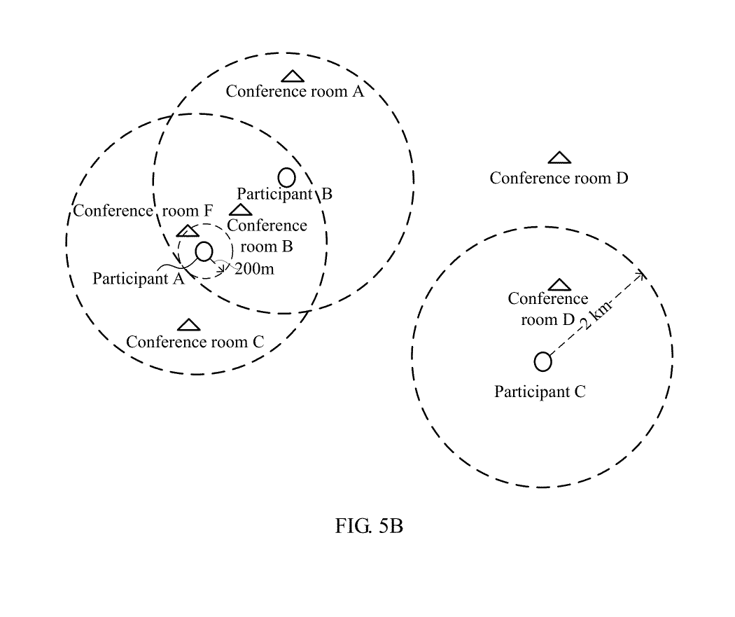

FIG. 4A is a schematic flowchart of a process of conference site booking according to an embodiment of the present invention. The embodiment shown in FIG. 4A is an example of the embodiment shown in FIG. 2. FIG. 4B is a schematic diagram of a user interface according to an embodiment of the present invention. FIG. 5A is a schematic diagram of locations of conference sites and participants according to an embodiment of the present invention. FIG. 5B is a schematic diagram of locations of conference sites and participants according to an embodiment of the present invention.

410. A conference site booking device receives identification information of multiple participants and time information of a conference that are input by a conference site booker.

To book a conference site for a conference, the conference site booker may log in to a conference management system or a conference site booking device in a user interface on a client, and input, in the user interface, identification information of participants who attend the conference and time information of the conference. In addition, a conference headline or topic of the conference may also be input. Referring to FIG. 4B, the conference site booker may select one or more participants, and participant information is a keyword that can indicate a participant, for example, an employee ID of an employee within a company. The conference site booker may also input only a name of a participant; after searching a database, the conference management system automatically prompts the conference site booker to select a specific participant. The time information may be an exact conference time, for example, 8:00 to 10:00 of a day. Optionally, one or more time ranges and conference duration may also be selected, and a time difference between end time and start time of each time range is greater than or equal to the conference duration.

The user interface may be an application program that is specially used to book a conference and is on the client; in this case, after receiving the identification information and the time information input by the conference site booker, the client may send the identification information and the time information to the conference site booking device through the Internet or a local area network. For example, the conference site booker may click a booking button in the user interface, and the client sends booking information to the conference site booking device after the booking button is clicked. Optionally, the user interface may also be configured on a terminal device of the conference site booking device.

420. The conference site booking device acquires location information of the multiple participants according to the identification information of the multiple participants.

After receiving the identification information, the conference site booking device may acquire the location information of the participants by means of association with other internal data information (for example, a personal address book directory) of a company. For example, the conference site booking device may query personal information by using a personal address book directory, where the personal address book directory may include location information (for example, geographical information), schedule information, and the like of individual persons. The personal address book directory may be in the conference site booking device, or may be in another server.

430. The conference site booking device may allocate, according to location information of each participant, the time information of the conference, and conference site information, a candidate conference site to the participant.

For example, the conference site booking device may firstly query, according to the location information of each participant, a conference site information list for conference sites that meet a distance requirement, and then select, according to the time information of the conference and from the conference sites that meet the distance requirement, a free conference site as the candidate conference site for the participant; or, the conference site booking device may firstly select free conference sites from a conference site information list according to the time information of the conference, and then select, according to the location information of each participant and from the free conference sites, a conference site that meets a distance requirement as the candidate conference site for the participant. The conference site booking device may also perform comprehensive analysis from all dimensions by using an internal integration algorithm, and provide a recommended conference attendance manner for each participant and an exact conference time; and for participants recommended to attend the conference by using a conference site, the conference site booking device may further recommend a conference site for each of the participants to attend the conference. For example, a free conference site within a preset range of the participant may be used as a candidate conference site of the participant.

Referring to FIG. 5A, it is assumed that a conference site within a range of 2 km from a participant is used as a candidate conference site for the participant; for example, candidate conference sites for a participant A include a conference site B, a conference site F, and a conference site C, candidate conference sites for a participant B include the conference site B, the conference site F, and a conference site A, a candidate conference site for a participant C includes a conference site D, and a conference site E is not used as a candidate conference site for any one participant of the participant A, the participant B, and the participant C.

440. The conference site booking device selects one conference site from candidate conference sites as a conference site for the at least two participants.

For example, in a case in which candidate conference sites allocated to the at least two participants have an intersection set, one conference site may be randomly selected from candidate conference sites that are included in the intersection set of the candidate conference sites allocated to the at least two participants. Referring to FIG. 5A again, an intersection set of the candidate conference sites for the participant B and the participant A includes: the conference site B and the conference site F. In this way, one conference site may be randomly selected from the conference site F and the conference site B for the participant A and the participant B as a final conference site of the participant A and the participant B, thereby saving conference site resources.

450. The conference site booking device sends a message to each participant, and notifies the participant of time and the conference site for attending the conference.

For example, the conference site booking device may send a conference notification to each participant by mail, SMS, or the like, so as to notify the participant of the time and the conference site for attending the conference.

460. The conference site booking device sends an instruction to an MCU, so that the MCU convokes the conference.

When the time for holding the conference arrives, the conference site booking device may send call numbers of selected conference sites to the MCU, to request the MCU to convoke the conference. For example, the MCU may instruct the conference sites to attend the conference by calling the call numbers of the selected conference sites.

Optionally, as a substitute embodiment of the embodiment shown in FIG. 4, in step 440, the conference site booking device may also select a candidate conference site with a shortest total distance to the at least two participants as a final conference site. Referring to FIG. 5A again, in the conference site F and the conference site B, a total distance from the conference site B to the participant A and the participant B is shorter than a total distance from the conference site F to the participant A and the participant B. Therefore, the conference site B is selected as a final conference site for the participant A and the participant B.

Optionally, as a substitute embodiment of the embodiment shown in FIG. 4, in step 450, the conference site booking device may also select, from the candidate conference sites that are included in the intersection set of the at least two participants, one conference site that has a largest number of participants whose distances to the conference site are less than a first threshold. FIG. 5B is a schematic diagram of locations of participants and conference sites according to another embodiment of the present invention. Referring to FIG. 5B, it is assumed that the first threshold is 200 m (for example, a distance that a participant can reach on foot within a preset time), that distances of the participant A and the participant B to the conference site B are greater than 200 m, and that a distance of the participant A to the conference site F is less than 200 m, that is, the number of participants whose distances to the conference site F are less than 200 m is greater than the number of participants whose distances to the conference site B are less than 200 m, and then the conference site F is selected as a final conference site for the participant A and the participant B.

Optionally, as a substitute embodiment of the embodiment shown in FIG. 4, in step 450, the conference site booking device may also select, from the candidate conference sites that are included in the intersection set, a conference site that has a highest utilization rate for the at least two participants. Referring to FIG. 5B again, it is assumed that the conference site F is a 2-people conference site, and that the conference site B is a 4-people conference site. If the conference site F is selected for the participant A and the participant B, a utilization rate of the conference site is 100%; if the conference site B is selected for the participant A and the participant B, a utilization rate of the conference site is 50%. Therefore, the conference site F that has a higher utilization rate is selected as a conference site for the participant A and the participant B.

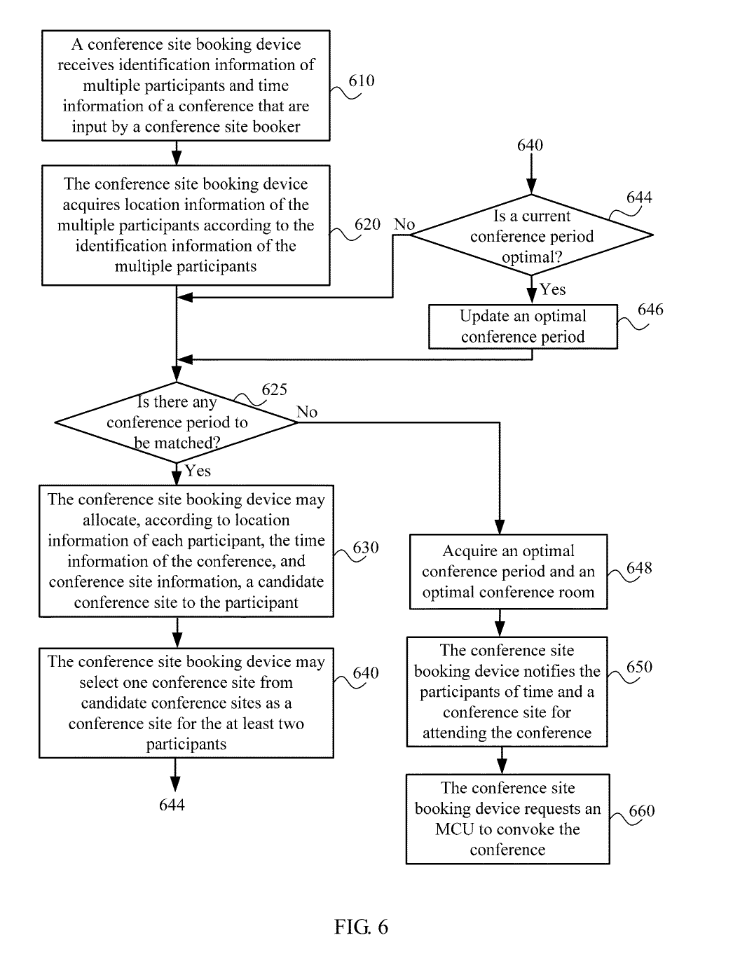

FIG. 6 is a schematic flowchart of a process of conference site booking according to another embodiment of the present invention. The embodiment shown in FIG. 6 is an example of the embodiment shown in FIGS. 2. 610, 620, 630, 640, 650, and 660 in FIG. 6 are similar to 410, 420, 430, 440, 450, and 460 in FIG. 4, and detailed descriptions are omitted appropriately herein.

610. A conference site booking device receives identification information of multiple participants and time information of a conference that are input by a conference site booker.

Different from the time information in 410 in FIG. 4, the time information in FIG. 6 may include a conference time range and conference duration. Referring to FIG. 4B, the conference time range is 8:00 to 12:00 on Nov. 30, 2012 or 8:00 to 12:00 on Dec. 1, 2012, and the conference duration is 2 hours.

620. The conference site booking device acquires location information of the multiple participants according to the identification information of the multiple participants.

625. Determine whether there is any conference period to be matched for the conference site booking device? If there is a conference period to be matched, proceed to execute 630; otherwise execute 648.

For example, the conference site booking device may divide the conference time range into multiple non-overlapping conference periods according to the conference duration. For example, 8:00 to 12:00 may be divided into two conference periods: 8:00 to 10:00 and 10:00 to 12:00. This embodiment of the present invention is not limited thereto. For example, in order to select a conference period more accurately, the conference time range may be divided into multiple overlapping conference periods. For example, 8:00 to 12:00 may be divided into five conference periods: 8:00 to 10:00, 8:30 to 10:30, 9:00 to 11:00, 9:30 to 11:30, and 10:00 to 12:00.

630. The conference site booking device may allocate, according to location information of each participant, the time information of the conference, and conference site information, a candidate conference site to the participant.

640. The conference site booking device may select one conference site from candidate conference sites as a conference site for the at least two participants.

644. The conference site booking device determines whether a current conference period is optimal.

The conference site booking device compares a conference site in the current conference period with a conference site in an optimal conference period determined according to a previous conference period, to re-determine an optimal conference period. If the current conference period is better than the optimal conference period that is determined previously, proceed to execute step 646; if the current conference period is not optimal, proceed to execute step 625.

646. The conference site booking device updates an optimal conference period, and proceeds to execute step 625. In other words, the current conference period is used as the optimal conference period, and accordingly, a conference site in the current conference period is used as an optimal conference site.

The conference site booking device may repeatedly execute steps 630 to 646 in the foregoing conference periods, so as to determine the optimal conference period and the corresponding optimal conference site. When compared with other schemes, conference sites in the optimal conference site scheme meet one of the following conditions: the sum of distances from the participants to their respective allocated conference sites in the optimal conference site scheme is the smallest; the number of participants whose distances to their respective allocated conference sites in the optimal conference site scheme are less than a first threshold in the participants is the largest; and a percentage of the total number of the participants to a capacity of all conference sites in the optimal conference site scheme is the highest.

648. The conference site booking device acquires an optimal conference period and a corresponding optimal conference site.

After matching is performed on the foregoing conference periods included in the conference time range, the final optimal conference period and corresponding optimal conference site may be obtained.

650. The conference site booking device notifies the participants of time and a conference site for attending the conference.

660. The conference site booking device requests an MCU to convoke the conference.

That a utilization rate of a conference site is the highest is used as an example for description. It is assumed that a video conference will be held from 09:00 to 11:00 in Wednesday morning, and the conference site booking device queries a personal address book directory and finds that 6 persons of participants work at a location A, 2 persons work at a location B, 6 persons work at a location C, and 1 person works at a location D; the conference site booking device queries a conference site directory and finds that: on Wednesday, an 8-people conference site is free in the whole morning at the location A, a 4-people conference site and a 6-people conference site are free in the whole morning at the location B, an 8-people video conference site is free from 9:00 to 10:00 at the location C, a 20-people conference site is free from 10:00 to 11:00 at the location C, and there is no conference site system deployed at the location D. A conference management system comprehensively assesses locations of the participants and utilization rates of conference site resources, and finally the conference site booking device recommends that the conference be held from 9:00 to 10:00 in Wednesday morning; the conference site booking device recommends the 8-people conference site at the location A, the 4-people conference site at the location B, the 8-people conference site at the location C, and recommends that the conference be attended by using a mobile PAD at the location D.

The conference site booking device analyzes whether the candidate conference sites are free within specific time periods, and finally selects a time period in which all the conference sites are free as the conference time. The conference site booking device automatically recommends a conference site and a conference time, comprehensively considers distribution and distances of all conference sites near the participants, whether the conference sites are free within the specific time periods, schedules of the participants, and the quantities of people that can be accommodated by the conference sites, and recommends one group or multiple groups of conference site booking list and booked time. For a participant without a conference site nearby, it may be recommended that the conference be attended by using a PC or a personal mobile device, or the conference be attended by using a phone in a voice manner. During conference site booking, a conference site booker may select one or more time ranges and conference duration, instead of being confined to book a conference site according to a fixed time period, thereby improving a success rate of conference site booking.

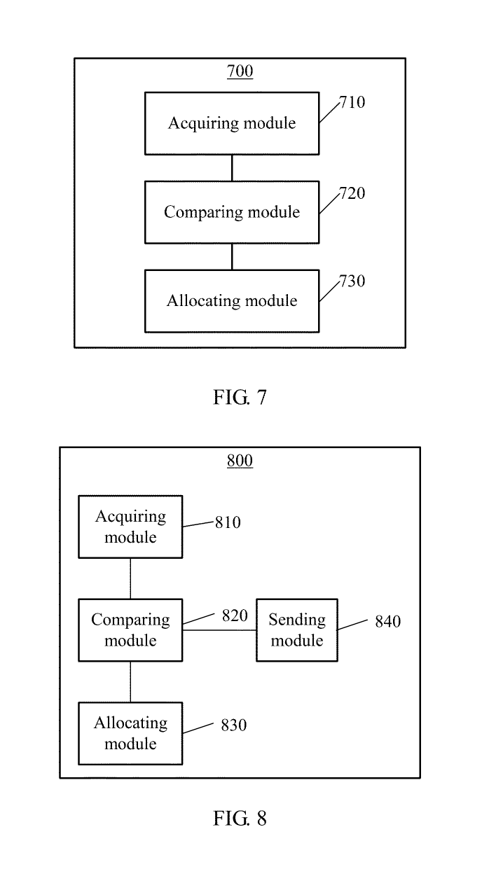

The method for booking a conference site according to the embodiments of the present invention is described above; in the following, an apparatus for booking a conference site according to the embodiments of the present invention is described with reference to FIG. 7 to FIG. 9.

FIG. 7 is a schematic structural diagram of an apparatus 700 for booking a conference site according to an embodiment of the present invention. The apparatus 700 includes: an acquiring module 710, a comparing module 720, and an allocating module 730. The apparatus 700 for booking a conference site may be implemented as the conference site booking device in FIG. 2 to FIG. 6.

The acquiring module 710 acquires location information of multiple participants in a participant list and time information of a conference, and acquires schedule information and location information of multiple conference sites. The comparing module 720 respectively compares the location information of the multiple participants and the time information of the conference that are acquired by the acquiring module 710 with the location information and the schedule information of the multiple conference sites that are acquired by the acquiring module 710, to obtain a first comparison result. The allocating module 730 allocates, to the multiple participants according to the first comparison result obtained by the comparing module 720, conference sites that meet a distance requirement and are free within a time indicated by the time information of the conference in the multiple conference sites.

In this embodiment of the present invention, a conference site booking device may allocate a conference site to a participant according to location information of the participant, time information of a conference, and location information and schedule information of conference sites, so as to automatically allocate conference sites to participants at different locations, which enables quick and effort-saving booking of a conference site for a conference and reduces the complexity of video conference booking.

For operations and functions of the acquiring module 710, the comparing module 720, and the allocating module 730 of the apparatus 700 for booking a conference site, reference may be made to steps 210, 220, and 230 of the methods shown in FIG. 2, which are not further described herein to prevent repetition.

FIG. 8 is a schematic structural diagram of an apparatus 800 for booking a conference site according to another embodiment of the present invention. The apparatus 800 includes: an acquiring module 810, a comparing module 820, and an allocating module 830. The acquiring module 810, the comparing module 820, and the allocating module 830 are similar to the acquiring module 710, the comparing module 720, and the allocating module 730 shown in FIG. 7, and are not further described herein to prevent repetition.

According to this embodiment of the present invention, the allocating module 830 allocates, to each participant of multiple participants, a candidate conference site whose distance to a location of the participant is less than a preset threshold and that is free within a time indicated by time information of a conference in multiple conference sites.

Optionally, as another embodiment, in a case in which free candidate conference sites that are allocated to at least two participants of the multiple participants have an intersection set, the allocating module 830 further randomly selects one conference site for the at least two participants from multiple free candidate conference sites that are included in the intersection set.

Optionally, as another embodiment, in a case in which free candidate conference sites that are allocated to at least two participants of the multiple participants have an intersection set, the comparing module 820 further compares total distances from locations of the at least two participants to all candidate conference sites of multiple free candidate conference sites that are included in the intersection set, to obtain a second comparison result; and the allocating module 830 further selects, for the at least two participants according to the second comparison result and from the multiple free candidate conference sites that are included in the intersection set, one conference site whose total distance to the at least two participants is the shortest, where a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

Optionally, as another embodiment, in a case in which free candidate conference sites that are allocated to at least two participants of the multiple participants have an intersection set, the comparing module 820 further compares distances from locations of the at least two participants to all candidate conference sites of multiple free candidate conference sites that are included in the intersection set, to obtain a third comparison result; and the allocating module 830 further selects, according to the third comparison result, a conference site for the at least two participants from the multiple free candidate conference sites that are included in the intersection set, where the selected conference site meets a requirement that the number of participants whose distances to the selected conference site are less than a first threshold in the at least two participants be the largest.

Optionally, as another embodiment, in a case in which free candidate conference sites that are allocated to at least two participants of the multiple participants have an intersection set, the comparing module 820 further compares percentages of the number of the at least two participants to capacities of all candidate conference sites of multiple free candidate conference sites that are included in the intersection set, to obtain a fourth comparison result; and the allocating module 830 further selects, for the at least two participants according to the fourth comparison result and from the multiple free candidate conference sites that are included in the intersection set, one conference site that has a highest percentage of the number of the at least two participants to a capacity of the candidate conference site.

Optionally, as another embodiment, in a case in which one of the at least two participants attends the conference as a group, the acquiring module 810 further receives an identifier of the group and the number of people in the group corresponding to the identifier that are input by a conference site booker in a user interface, where the number of the at least two participants is determined according to the number of people in the group and the number of other participants in the at least two participants.

Optionally, as another embodiment, the apparatus 800 further includes a sending module 840. The sending module 840 sends, to a user interface, identifiers of multiple free candidate conference sites that are allocated by the allocating module 830 to one of the multiple participants, so that a conference site booker selects one conference site from the multiple free candidate conference sites; the acquiring module 810 further receives, from the user interface, an identifier of the conference site selected by the conference site booker; and the allocating module 830 further uses, according to the identifier of the conference site selected by the conference site booker that is received from the user interface, the selected conference site as a conference site for the one of the multiple participants.

Optionally, as another embodiment, the acquiring module 810 receives the time information of the conference that is input by the conference site booker in the user interface, queries, according to the time information of the conference, a conference site information list for the location information and the schedule information of the conference sites, receives identification information of the multiple participants and the time information of the conference that are input by the conference site booker in the user interface, and queries, according to the identification information of the multiple participants, a personal information list for the location information of the multiple participants, where the conference site information list is stored in the conference site booking device or a conference site information server, and the personal information list is stored in the conference site booking device or a personal information server.

Optionally, as another embodiment, the time information of the conference includes multiple conference periods; the allocating module 830 determines, from the multiple conference sites, conference site schemes corresponding to at least two periods for the multiple participants, where each conference site scheme of the conference site schemes corresponding to the at least two periods provides, for the multiple participants, the conference sites that meet the distance requirement and are free within the time indicated by the time information of the conference; and the allocating module 830 selects an optimal conference site scheme from the conference site schemes corresponding to the at least two conference periods, where when compared with one or more other schemes of the conference site schemes corresponding to the at least two conference periods, conference sites in the optimal conference site scheme meet one of the following conditions: the sum of distances from the multiple participants to their respective allocated conference sites in the optimal conference site scheme is the smallest; the number of participants whose distances to their respective allocated conference sites in the optimal conference site scheme are less than the first threshold in the multiple participants is the largest; and a percentage of the total number of the multiple participants to a capacity of all conference sites in the optimal conference site scheme is the highest.

Optionally, as another embodiment, the time information of the conference includes multiple conference periods; the acquiring module 810 further receives the identification information of the multiple participants that is input by the conference site booker in the user interface, and queries schedule information of the multiple participants according to the identification information of the multiple participants, where the schedule information of the multiple participants is stored in the conference site booking device or the personal information server; and the allocating module 830 removes, according to schedules indicated by the schedule information of the multiple participants and from the multiple conference periods, a conference period that conflicts with a schedule of at least one participant of the multiple participants, to obtain a remaining conference period, respectively compares the location information of the multiple participants and the remaining conference period with the location information and the schedule information of the multiple conference sites, and allocates, to the multiple participants, the conference sites that meet the distance requirement and are free within the time indicated by the time information of the conference in the multiple conference sites.

Optionally, as another embodiment, the allocating module 830 further requests a participant to whom no conference site is allocated in the multiple participants to use a mobile device to attend the conference.

For operations and functions of the acquiring module 810, the comparing module 820, and the allocating module 830 of the apparatus 800 for booking a conference site, reference may be made to the methods in 210, 220, 230, and 240 shown in FIG. 2, which are not further described herein to prevent repetition.

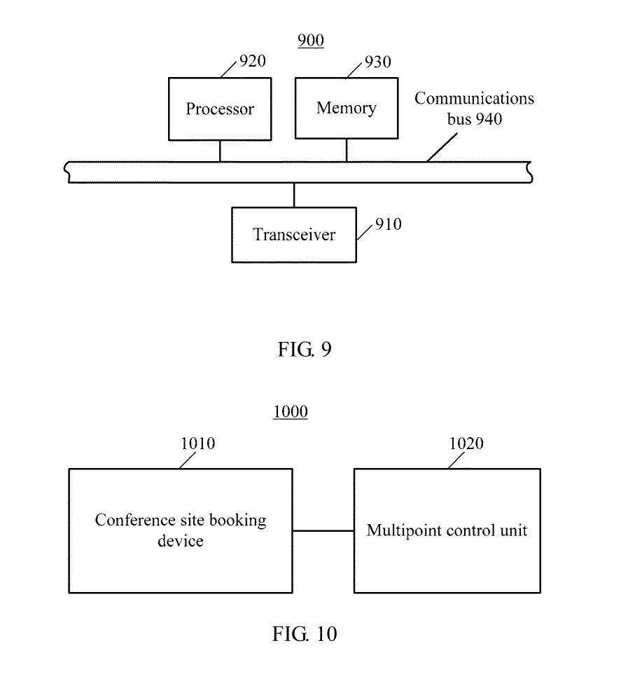

FIG. 9 is a schematic structural diagram of a conference site booking device 900 according to an embodiment of the present invention. The conference site booking device 900 includes: a transceiver 910, a processor 920, a memory 930, and a communications bus 940.

The transceiver 910 acquires location information of multiple participants in a participant list and time information of a conference, and acquires schedule information and location information of multiple conference sites. The processor 920 invokes code stored in the memory 930 by using the communications bus 940, and is configured to respectively compare the location information of the multiple participants and the time information of the conference that are acquired by the transceiver 910 with the location information and the schedule information of the multiple conference sites that are acquired by the transceiver 910, to obtain a first comparison result. The processor 920 allocates, to the multiple participants according to the first comparison result, conference sites that meet a distance requirement and are free within a time indicated by the time information of the conference in the multiple conference sites.

In this embodiment of the present invention, a conference site booking device may allocate a conference site to a participant according to location information of the participant, time information of a conference, and location information and schedule information of conference sites, so as to automatically allocate conference sites to participants at different locations, which enables quick and effort-saving booking of a conference site for a conference and reduces the complexity of video conference booking.

According to this embodiment of the present invention, the processor 920 allocates, to each participant of the multiple participants, a candidate conference site whose distance to a location of the participant is less than a preset threshold and that is free within the time indicated by the time information of the conference in the multiple conference sites.

Optionally, as another embodiment, in a case in which free candidate conference sites that are allocated to at least two participants of the multiple participants have an intersection set, the processor 920 further randomly selects one conference site for the at least two participants from multiple free candidate conference sites that are included in the intersection set.

Optionally, as another embodiment, in a case in which free candidate conference sites that are allocated to at least two participants of the multiple participants have an intersection set, the processor 920 further compares total distances from locations of the at least two participants to all candidate conference sites of multiple free candidate conference sites that are included in the intersection set, to obtain a second comparison result; and the processor 920 further selects, for the at least two participants according to the second comparison result and from the multiple free candidate conference sites that are included in the intersection set, one conference site whose total distance to the at least two participants is the shortest, where a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

According to this embodiment of the present invention, in a case in which free candidate conference sites that are allocated to at least two participants of the multiple participants have an intersection set, the processor 920 further compares distances from locations of the at least two participants to all candidate conference sites of multiple free candidate conference sites that are included in the intersection set, to obtain a third comparison result; and the processor 920 further selects, according to the third comparison result, a conference site for the at least two participants from the multiple free candidate conference sites that are included in the intersection set, where the selected conference site meets a requirement that the number of participants whose distances to the selected conference site are less than a first threshold in the at least two participants be the largest.

Optionally, as another embodiment, in a case in which free candidate conference sites that are allocated to at least two participants of the multiple participants have an intersection set, the processor 920 further compares percentages of the number of the at least two participants to capacities of all candidate conference sites of multiple free candidate conference sites that are included in the intersection set, to obtain a fourth comparison result; and the processor 920 further selects, for the at least two participants according to the fourth comparison result and from the multiple free candidate conference sites that are included in the intersection set, one conference site that has a highest percentage of the number of the at least two participants to a capacity of the candidate conference site.

According to this embodiment of the present invention, in a case in which one of the at least two participants attends the conference as a group, the transceiver 910 further receives an identifier of the group and the number of people in the group corresponding to the identifier that are input by a conference site booker in a user interface, where the number of the at least two participants is determined according to the number of people in the group and the number of other participants in the at least two participants.

Optionally, as another embodiment, the transceiver 910 sends, to a user interface, identifiers of multiple free candidate conference sites that are allocated by the processor 920 to one of the multiple participants, so that a conference site booker selects one conference site from the multiple free candidate conference sites; the transceiver 910 further receives, from the user interface, an identifier of the conference site selected by the conference site booker; and the processor 920 further uses, according to the identifier of the conference site selected by the conference site booker that is received from the user interface, the selected conference site as a conference site for the one of the multiple participants.

Optionally, as another embodiment, the transceiver 910 receives the time information of the conference that is input by the conference site booker in the user interface, queries, according to the time information of the conference, a conference site information list for the location information and the schedule information of the conference sites, receives identification information of the multiple participants and the time information of the conference that are input by the conference site booker in the user interface, and queries, according to the identification information of the multiple participants, a personal information list for the location information of the multiple participants, where the conference site information list is stored in the conference site booking device or a conference site information server, and the personal information list is stored in the conference site booking device or a personal information server.

Optionally, as another embodiment, the time information of the conference includes multiple conference periods; the processor 920 determines, from the multiple conference sites, conference site schemes corresponding to at least two periods for the multiple participants, where each conference site scheme of the conference site schemes corresponding to the at least two periods provides, for the multiple participants, the conference sites that meet the distance requirement and are free within the time indicated by the time information of the conference; and the processor 920 selects an optimal conference site scheme from the conference site schemes corresponding to the at least two conference periods, where when compared with one or more other schemes of the conference site schemes corresponding to the at least two conference periods, conference sites in the optimal conference site scheme meet one of the following conditions: the sum of distances from the multiple participants to their respective allocated conference sites in the optimal conference site scheme is the smallest; the number of participants whose distances to their respective allocated conference sites in the optimal conference site scheme are less than the first threshold in the multiple participants is the largest; and a percentage of the total number of the multiple participants to a capacity of all conference sites in the optimal conference site scheme is the highest.

Optionally, as another embodiment, the time information of the conference includes multiple conference periods; the transceiver 910 further receives the identification information of the multiple participants that is input by the conference site booker in the user interface, and queries schedule information of the multiple participants according to the identification information of the multiple participants, where the schedule information of the multiple participants is stored in the conference site booking device or the personal information server; and the processor 920 removes, according to schedules indicated by the schedule information of the multiple participants and from the multiple conference periods, a conference period that conflicts with a schedule of at least one participant of the multiple participants, to obtain a remaining conference period, respectively compares the location information of the multiple participants and the remaining conference period with the location information and the schedule information of the multiple conference sites, and allocates, to the multiple participants, the conference sites that meet the distance requirement and are free within the time indicated by the time information of the conference in the multiple conference sites.

Optionally, as another embodiment, the processor 920 further requests a participant to whom no conference site is allocated in the multiple participants to use a mobile device to attend the conference.

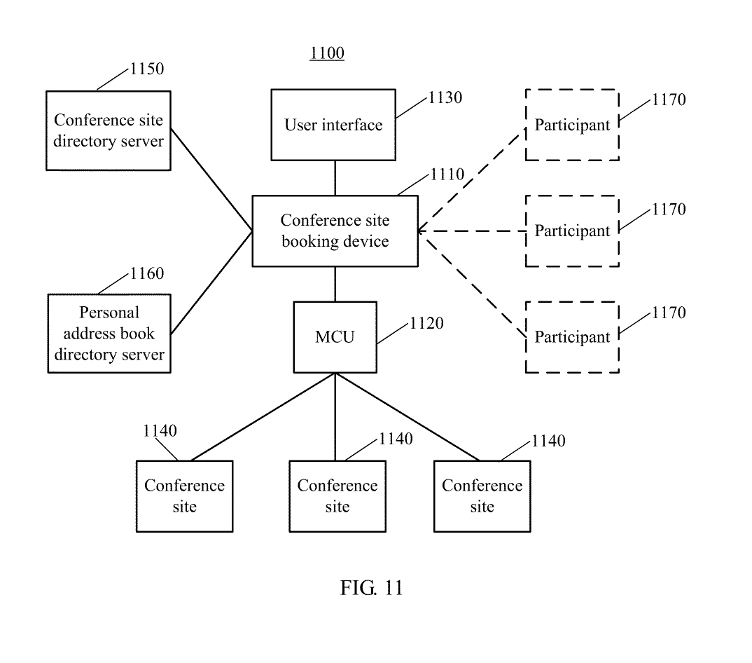

The method and apparatus for booking a conference site according to the embodiments of the present invention are described above; in the following, a conference system according to the embodiments of the present invention is described with reference to FIG. 10 and FIG. 11.

FIG. 10 is a schematic structural diagram of a conference system 1000 according to an embodiment of the present invention.

The conference system 1000 includes a conference site booking device 1010 and a multipoint control unit (Multipoint Control Unit, MCU) 1020. The conference site booking device 1010 is an example of the apparatuses for booking a conference site shown in FIG. 7 and FIG. 8, and is not further described herein to prevent repetition.

The conference site booking device 1010 acquires location information of multiple participants in a participant list and time information of a conference, acquires schedule information and location information of multiple conference sites, respectively compares the location information of the multiple participants and the time information of the conference with the location information and the schedule information of the multiple conference sites, to obtain a first comparison result, and allocates, to the multiple participants according to the first comparison result, conference sites that meet a distance requirement and are free within a time indicated by the time information of the conference in the multiple conference sites. The multipoint control unit 1020 receives a conference start notification sent by the apparatus for booking a conference site, and according to the conference start notification, calls a conference site corresponding to the conference site selected by the apparatus for booking a conference site to attend the conference.

In this embodiment of the present invention, a conference site booking device may allocate a conference site to a participant according to location information of the participant, time information of a conference, and location information and schedule information of conference sites, so as to automatically allocate conference sites to participants at different locations, which enables quick and effort-saving booking of a conference site for a conference and reduces the complexity of video conference booking.

FIG. 11 is a schematic structural diagram of a conference system 1100 according to another embodiment of the present invention. The conference system 1100 is an example of the conference system 1000.

The conference system 1100 includes: a conference site booking device 1110, an MCU 1120, a user interface 1130, multiple conference sites 1140, a conference site directory server 1150, and a personal address book directory server 1160. The conference site booking device 1110 is an example of the conference site booking device 700 shown in FIG. 7 and the conference site booking device 800 shown in FIG. 8, and is not further described herein to prevent repetition.

The user interface 1130 receives identification information of multiple participants and time information of a conference that are input by a conference site booker, and sends the identification information of the multiple participants and the time information of the conference to the conference site booking device 1110. The conference site booking device 1110 acquires, according to the identification information of the multiple participants, location information of the multiple participants from the personal address book directory server 1160. The conference site booking device 1110 acquires location information of the conference sites from the conference site directory server 1150. The conference site booking device 1110 allocates conference sites and a corresponding conference time to the multiple participants according to the location information of the multiple participants, the time information of the conference, and the location information of the conference sites. The conference site booking device 1110 notifies participants 1170 of the conference sites that are allocated to the multiple participants and the corresponding conference time, and the conference site booking device 1110 sends a conference start notification when the conference time arrives. The MCU 1120 receives the conference start notification sent by the conference site booking device 1110, and according to the conference start notification, calls a conference site 1140 corresponding to a conference site selected by the conference site booking device 1110 to attend the conference.

A person of ordinary skill in the art may be aware that, in combination with the examples described in the embodiments disclosed in this specification, units and algorithm steps may be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of the present invention.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present invention, it should be understood that the disclosed system, apparatus, and method may be implemented in other manners. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical, or other forms.

The units described as separate parts may or may not be physically separate, and parts displayed as units may or may not be physical units, may be located in one position, or may be distributed on a plurality of network units. Some or all of the units may be selected according to actual needs to achieve the objectives of the solutions of the embodiments.

In addition, functional units in the embodiments of the present invention may be integrated into one processing unit, or each of the units may exist alone physically, or two or more units are integrated into one unit.

When the functions are implemented in the form of a software functional unit and sold or used as an independent product, the functions may be stored in a computer-readable storage medium. Based on such an understanding, the technical solutions of the present invention essentially, or the part contributing to the prior art, or some of the technical solutions may be implemented in a form of a software product. The software product is stored in a storage medium and includes several instructions for instructing a computer device (which may be a personal computer, a server, or a network device) or a processor to perform all or some of the steps of the methods described in the embodiments of the present invention. The foregoing storage medium includes: any medium that can store program code, such as a USB flash drive, a removable hard disk, a read-only memory (ROM, Read-Only Memory), a random access memory (RAM, Random Access Memory), a magnetic disk, or an optical disc.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. A method for booking a video conference site, comprising:
acquiring, by a conference site booking device, location information of multiple participants in a participant list and time information of a conference;
acquiring, by the conference site booking device, schedule information and location information of multiple conference sites;
respectively comparing, by the conference site booking device, the location information of the multiple participants and the time information of the conference with the location information and the schedule information of the multiple conference sites, to obtain a first comparison result; and
allocating, by the conference site booking device according to the first comparison result, conference sites that meet a distance requirement and are free within a time indicated by the time information of the conference in the multiple conference sites to the multiple participants.

2. The method according to claim 1, wherein the allocating conference sites that meet a distance requirement and are free within a time indicated by the time information of the conference in the multiple conference sites to the multiple participants comprises:
allocating, to each participant of the multiple participants, a candidate conference site whose distance to a location of the participant is less than a preset threshold and that is free within the time indicated by the time information of the conference in the multiple conference sites.

3. The method according to claim 2, wherein, in a case in which free candidate conference sites that are allocated to at least two participants of the multiple participants have an intersection set, the method further comprises:
comparing, by the conference site booking device, total distances from locations of the at least two participants to all candidate conference sites of multiple free candidate conference sites that are comprised in the intersection set, to obtain a second comparison result; and
selecting, by the conference site booking device for the at least two participants according to the second comparison result and from the multiple free candidate conference sites that are comprised in the intersection set, one conference site whose total distance to the at least two participants is the shortest, wherein
a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

4. The method according to claim 2, wherein, in a case in which free candidate conference sites that are allocated to at least two participants of the multiple participants have an intersection set, the method further comprises:
comparing, by the conference site booking device, distances from locations of the at least two participants to all candidate conference sites of multiple free candidate conference sites that are comprised in the intersection set, to obtain a third comparison result; and
selecting, by the conference site booking device according to the third comparison result, a conference site for the at least two participants from the multiple free candidate conference sites that are comprised in the intersection set, wherein the selected conference site meets a requirement that the number of participants whose distances to the selected conference site are less than a first threshold in the at least two participants be the largest.

5. The method according to claim 2, wherein, in a case in which free candidate conference sites that are allocated to at least two participants of the multiple participants have an intersection set, the method further comprises:
comparing, by the conference site booking device, percentages of the number of the at least two participants to capacities of all candidate conference sites of multiple free candidate conference sites that are comprised in the intersection set, to obtain a fourth comparison result; and
selecting, by the conference site booking device for the at least two participants according to the fourth comparison result and from the multiple free candidate conference sites that are comprised in the intersection set, one conference site that has a highest percentage of the number of the at least two participants to a capacity of the candidate conference site.

6. The method according to claim 5, wherein, in a case in which one of the at least two participants attends the conference as a group, the method further comprises:
receiving, by the conference site booking device, an identifier of the group and the number of people in the group corresponding to the identifier that are input by a conference site booker in a user interface, wherein the number of the at least two participants is determined according to the number of people in the group and the number of other participants in the at least two participants.

7. The method according to claim 2, further comprising:
sending, by the conference site booking device to a user interface, identifiers of multiple free candidate conference sites that are allocated to one of the multiple participants, so that a conference site booker selects one conference site from the multiple free candidate conference sites;
receiving, by the conference site booking device from the user interface, an identifier of the conference site selected by the conference site booker; and
using, by the conference site booking device according to the identifier of the conference site selected by the conference site booker that is received from the user interface, the selected conference site as a conference site for the one of the multiple participants.

8. The method according to claim 2, wherein the conference site booking device receives the time information of the conference that is input by the conference site booker in the user interface;
the acquiring, by the conference site booking device, schedule information and location information of multiple conference sites comprises:
querying, by the conference site booking device according to the time information of the conference, a conference site information list for the location information and the schedule information of the conference sites; and
the acquiring, by a conference site booking device, location information of multiple participants in a participant list and time information of a conference comprises:
receiving, by the conference site booking device, identification information of the multiple participants and the time information of the conference that are input by the conference site booker in the user interface; and
querying, by the conference site booking device according to the identification information of the multiple participants, a personal information list for the location information of the multiple participants; wherein the conference site information list is stored in the conference site booking device or a conference site information server, and the personal information list is stored in the conference site booking device or a personal information server.

9. The method according to claim 1, wherein the time information of the conference comprises multiple conference periods; and
the allocating conference sites that meet a distance requirement and are free within a time indicated by the time information of the conference in the multiple conference sites to the multiple participants comprises:
determining, by the conference site booking device from the multiple conference sites, conference site schemes corresponding to at least two periods for the multiple participants, wherein each conference site scheme of the conference site schemes corresponding to the at least two periods provides, for the multiple participants, the conference sites that meet the distance requirement and are free within the time indicated by the time information of the conference; and
selecting, by the conference site booking device, an optimal conference site scheme from the conference site schemes corresponding to the at least two conference periods, wherein when compared with one or more other schemes of the conference site schemes corresponding to the at least two conference periods, conference sites in the optimal conference site scheme meet one of the following conditions:
the sum of distances from the multiple participants to their respective allocated conference sites in the optimal conference site scheme is the smallest;
the number of participants whose distances to their respective allocated conference sites in the optimal conference site scheme are less than the first threshold in the multiple participants is the largest; and
a percentage of the total number of the multiple participants to a capacity of all conference sites in the optimal conference site scheme is the highest.

10. The method according to claim 1, wherein the time information of the conference comprises multiple conference periods; and the method further comprises:
receiving, by the conference site booking device, the identification information of the multiple participants that is input by the conference site booker in the user interface; and
querying, by the conference site booking device, schedule information of the multiple participants according to the identification information of the multiple participants, wherein the schedule information of the multiple participants is stored in the conference site booking device or the personal information server; wherein
the allocating conference sites that meet a distance requirement and are free within a time indicated by the time information of the conference in the multiple conference sites to the multiple participants comprises:
removing, by the conference site booking device according to schedules indicated by the schedule information of the multiple participants and from the multiple conference periods, a conference period that conflicts with a schedule of at least one participant of the multiple participants, to obtain a remaining conference period; and
respectively comparing, by the conference site booking device, the location information of the multiple participants and the remaining conference period with the location information and the schedule information of the multiple conference sites, and allocating, to the multiple participants, the conference sites that meet the distance requirement and are free within the time indicated by the time information of the conference in the multiple conference sites.

11. An apparatus for booking a conference site, comprising:
an acquiring module, configured to acquire location information of multiple participants in a participant list and time information of a conference, and acquire schedule information and location information of multiple conference sites;
a comparing module, configured to respectively compare the location information of the multiple participants and the time information of the conference that are acquired by the acquiring module with the location information and the schedule information of the multiple conference sites that are acquired by the acquiring module, to obtain a first comparison result; and
an allocating module, configured to allocate, to the multiple participants according to the first comparison result obtained by the comparing module, conference sites that meet a distance requirement and are free within a time indicated by the time information of the conference in the multiple conference sites.

12. The apparatus according to claim 11, wherein the allocating module allocates, to each participant of the multiple participants, a candidate conference site whose distance to a location of the participant is less than a preset threshold and that is free within the time indicated by the time information of the conference in the multiple conference sites.

13. The apparatus according to claim 12, wherein, in a case in which free candidate conference sites that are allocated to at least two participants of the multiple participants have an intersection set, the comparing module further compares total distances from locations of the at least two participants to all candidate conference sites of multiple free candidate conference sites that are comprised in the intersection set, to obtain a second comparison result; and the allocating module further selects, for the at least two participants according to the second comparison result and from the multiple free candidate conference sites that are comprised in the intersection set, one conference site whose total distance to the at least two participants is the shortest, wherein a total distance from the at least two participants to a candidate conference site refers to the sum of distances from the at least two participants to the candidate conference site; or, a total distance from the at least two participants to a candidate conference site refers to the sum of products that are obtained by multiplying distances from the locations of the at least two participants to the candidate conference site by respective weighting coefficients.

14. The apparatus according to claim 12, wherein, in a case in which free candidate conference sites that are allocated to at least two participants of the multiple participants have an intersection set, the comparing module further compares distances from locations of the at least two participants to all candidate conference sites of multiple free candidate conference sites that are comprised in the intersection set, to obtain a third comparison result; and the allocating module further selects, according to the third comparison result, a conference site for the at least two participants from the multiple free candidate conference sites that are comprised in the intersection set, wherein the selected conference site meets a requirement that the number of participants whose distances to the selected conference site are less than a first threshold in the at least two participants be the largest.

15. The apparatus according to claim 12, wherein, in a case in which free candidate conference sites that are allocated to at least two participants of the multiple participants have an intersection set, the comparing module further compares percentages of the number of the at least two participants to capacities of all candidate conference sites of multiple free candidate conference sites that are comprised in the intersection set, to obtain a fourth comparison result; and the allocating module further selects, for the at least two participants according to the fourth comparison result and from the multiple free candidate conference sites that are comprised in the intersection set, one conference site that has a highest percentage of the number of the at least two participants to a capacity of the candidate conference site.

16. The apparatus according to claim 12, further comprising:
a sending module, configured to send, to a user interface, identifiers of multiple free candidate conference sites that are allocated by the allocating module to one of the multiple participants, so that a conference site booker selects one conference site from the multiple free candidate conference sites, wherein the acquiring module further receives, from the user interface, an identifier of the conference site selected by the conference site booker; and the allocating module further uses, according to the identifier of the conference site selected by the conference site booker that is received from the user interface, the selected conference site as a conference site for the one of the multiple participants.

17. The apparatus according to claim 12, wherein the acquiring module receives the time information of the conference that is input by the conference site booker in the user interface, queries, according to the time information of the conference, a conference site information list for the location information and the schedule information of the conference sites, receives identification information of the multiple participants and the time information of the conference that are input by the conference site booker in the user interface, and queries, according to the identification information of the multiple participants, a personal information list for the location information of the multiple participants, wherein the conference site information list is stored in the conference site booking device or a conference site information server, and the personal information list is stored in the conference site booking device or a personal information server.

18. The apparatus according to claim 11, wherein the time information of the conference comprises multiple conference periods; the allocating module determines, from the multiple conference sites, conference site schemes corresponding to at least two periods for the multiple participants, wherein each conference site scheme of the conference site schemes corresponding to the at least two periods provides, for the multiple participants, the conference sites that meet the distance requirement and are free within the time indicated by the time information of the conference; and the allocating module selects an optimal conference site scheme from the conference site schemes corresponding to the at least two conference periods, wherein when compared with one or more other schemes of the conference site schemes corresponding to the at least two conference periods, conference sites in the optimal conference site scheme meet one of the following conditions: the sum of distances from the multiple participants to their respective allocated conference sites in the optimal conference site scheme is the smallest; the number of participants whose distances to their respective allocated conference sites in the optimal conference site scheme are less than the first threshold in the multiple participants is the largest; and a percentage of the total number of the multiple participants to a capacity of all conference sites in the optimal conference site scheme is the highest.

19. The apparatus according to claim 11, wherein the time information of the conference comprises multiple conference periods; the acquiring module further receives the identification information of the multiple participants that is input by the conference site booker in the user interface, and queries schedule information of the multiple participants according to the identification information of the multiple participants, wherein the schedule information of the multiple participants is stored in the conference site booking device or the personal information server; and the allocating module removes, according to schedules indicated by the schedule information of the multiple participants and from the multiple conference periods, a conference period that conflicts with a schedule of at least one participant of the multiple participants, to obtain a remaining conference period, respectively compares the location information of the multiple participants and the remaining conference period with the location information and the schedule information of the multiple conference sites, and allocates, to the multiple participants, the conference sites that meet the distance requirement and are free within the time indicated by the time information of the conference in the multiple conference sites.

20. A conference system, comprising: a conference site booking device and a multipoint control unit;
the conference site booking device, is configured to: acquire location information of multiple participants in a participant list and time information of a conference, acquire schedule information and location information of multiple conference sites, respectively compare the location information of the multiple participants and the time information of the conference with the location information and the schedule information of the multiple conference sites, to obtain a first comparison result, allocate according to the first comparison result, conference sites that meet a distance requirement and are free within a time indicated by the time information of the conference in the multiple conference sites to the multiple participants, and send a conference start notification when conference time arrives;
the multipoint control unit, is configured to: receive the conference start notification sent by the apparatus for booking a conference site; and according to the conference start notification, call a conference site corresponding to a conference site selected by the apparatus for booking a conference site to attend a conference.
